(19) United States
(12) Patent Application Publication
(10) Pub. No.: US 2019/0070499 A1
(43) Pub. Date: Mar. 7, 2019

(54) Haptic Feedback Device With Steering Simulation

(71) Applicant: Brogent Technologies Inc., Kaohsiung City (TW)

(72) Inventors: Chih-Hung OU Yang, Kaohsiung City (TW); Yih-Chang Hsieh, Kaohsiung City (TW); Meng-Wen Li, Kaohsiung City (TW)

(21) Appl. No.: 15/694,989

(22) Filed: Sep. 4, 2017

(51) Int. Cl. A63F 13/285

(52) U.S. Cl. CPC A63F 13/285

(57) ABSTRACT

A haptic feedback device with steering simulation comprises a base unit, a rolling unit, a carrying unit, and a power unit. The base unit includes a base platform. The rolling unit includes a rolling base pivotally connected to the base platform, so that the rolling base opposed to the base platform can swing in leftward or rightward direction. The carrying unit includes a horizontal carriage body, and a vertical supporting body. Bottom of the vertical supporting body is pivotally connected to the rolling base, and top of the vertical supporting body is connected to the horizontal carriage body. The power unit includes a first power component controlling movement of the horizontal carriage body, and a second power unit controlling the swing of the rolling unit.

### FIELD OF THE INVENTION

The present invention relates to a haptic feedback device, and more particularly to a haptic feedback device with steering simulation.

### BACKGROUND

In electronic game arcades, haptic feedback arcade games are popular with players, because they can interact with players and offer exercise feedback, player can experience virtual reality with accompanying visual and audio presentations, which makes haptic feedback arcade games welcomed.

Please refer to FIG. 1, which concerns Taiwan Patent No. 1357346, a motorcycle gaming device 30 with wheel slip effect, which includes a motorcycle body 32, a tilt mechanism 38, and a rolling mechanism 40. The rolling mechanism 40 is located below the motorcycle body 32 and the tilt mechanism 38, including an axis 70 and a motor 72. A first pulley 7002 is disposed on the axis 70, a second pulley 7202 disposed on the motor 72, a belt 74 disposed between the first and the second pulleys 7002, 7202 for rolling, and the motion of body 32 is controlled by the motor 72, so that the motorcycle body 32 can simulate the wheel slip.

Besides, some well-developed motorcycle companies produce racing training simulators for simulating acceleration, braking and steering. In addition, movement of motorcycle is presented by three degrees of freedom: roll, pitch, and yaw.

Please refer to FIG. 2, which concerns U.S. Pat. No. 5,209,662 A, entitled “Riding simulation system of motorcycle”, which includes a base 1, a movable carriage 2, a movable mechanisms 6, and a model motorcycle 13. A slide member 7 being capable to slide the model motorcycle 13, an elevation frames 8 being capable to elevate the model motorcycle 13, and a motor 17 being capable to lean the model motorcycle 13 in leftward or rightward direction are disposed on the movable mechanisms 6.

In the aforementioned riding simulation system, the roll movement constructed by the motor 17, the pitch movement constructed by the movable carriage 2, and the yaw movement is constructed by the slide member 7, so that the actual riding experience can be simulated for training.

Although the riding experience can be simulated by current arcade games and professional riding simulation system, however, providing more realistic haptic feedback still cannot be achieved by the current device and system.

Although the wheel slip effect constructed by rolling mechanism and the motorcycle acceleration/deceleration simulated by curved rail are disclosed by the prior art, but the presented haptic feedback is not realistic enough.

Therefore, developing a haptic feedback device with more realistic haptic feedback of wheel slip and acceleration/deceleration is the objective those in the field are seeking to achieve.

### SUMMARY OF THE INVENTION

Therefore, an objective of an embodiment of the present invention is to provide a haptic feedback device with steering simulation, comprising a base unit, a rolling unit, a carrying unit and a power unit.

The base unit includes a base platform.

The rolling unit includes a rolling base pivotally connected to the base platform, so that the rolling base opposed to the base platform can swing in leftward or rightward direction.

The carrying unit includes a horizontal carriage body, and a vertical supporting body. Bottom of the vertical supporting body is pivotally connected to the rolling base, and top of the vertical supporting body is connected to the horizontal carriage body.

The power unit includes a first power component controlling movement of the horizontal carriage body.

Another technique of an embodiment of the present invention is that a roll center is defined where bottom of the vertical supporting body is pivotally connected to the rolling base. A circle can be obtained with center at roll center and radius equal to vertical length of the vertical supporting body. The horizontal carriage body is disposed on a tangent line to the circle.

Another technique of an embodiment of the present invention is that a rolling supporting body is stretched out from the rolling base, and the first power component pivotally connected to bottom of the vertical supporting body is an actuator.

Another technique of an embodiment of the present invention is that a rolling supporting body is stretched out from the rolling base, and top of the rolling supporting body is pivotally connected to bottom of the vertical supporting body.

Another technique of an embodiment of the present invention is that the rolling supporting body is a curve shape.

Another technique of an embodiment of the present invention is that the power unit further includes a second power component to control the swing of the rolling base.

Another technique of an embodiment of the present invention is that the base unit further includes a rotating member located below the base platform, so that the base platform can rotate.

Another technique of an embodiment of the present invention is that the power unit further includes a power transmission member, which is connected to the second power component, so that the rolling base and the base platform can be driven by the second power component at the same time for rolling.

Another technique of an embodiment of the present invention is that the power unit further includes a third power component to control rotation of the base platform.

Another technique of an embodiment of the present invention is that the present invention further includes a gaming unit which is provided with a seat member located on the horizontal carrying body, an order detecting component located on the horizontal carrying body, a game controlling component for executing a game program, and a game display component electrically connected to the game controlling component. The seat member is provided for a person to ride, and the person sends an order to game controlling component via the order detecting component, so that the game image can be shown on the game display component by the game controlling component, and the power unit can be controlled at the same time.

An advantage of embodiments of the invention is that by using the roll center where bottom of the vertical supporting body is pivotally connected to the rolling base, the horizontal carrying body can be disposed on a tangent line to the circle. Moreover, the horizontal carrying body is separated from the tangent point of circle at certain distance, so that when the upward and downward movement of the horizontal carrying body can be controlled by the first power component. The radian measure of the front end of the horizontal carrying body is larger than the rear end, so that stoppie experience can be simulated, and with the rolling base platform, the haptic feedback of wheel slip can also be simulated.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 is a side view of Taiwan Patent No. 1357346, a motorcycle gaming device with wheel slip effect;

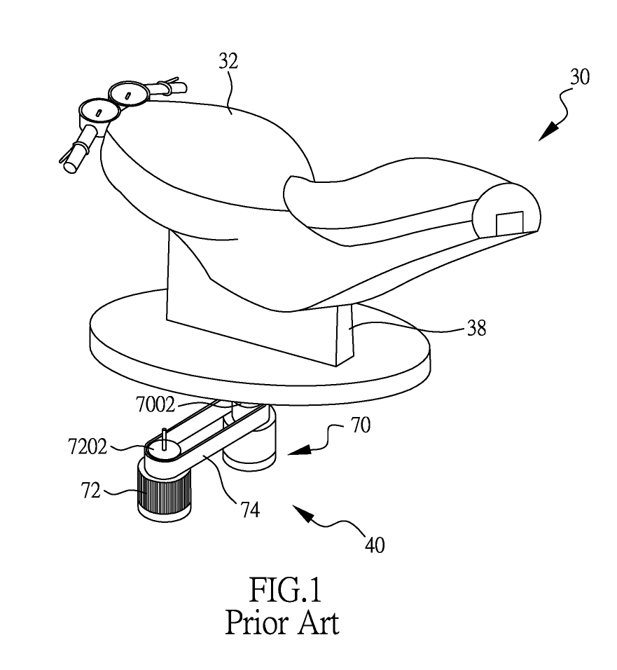

FIG. 2 is a side view of U.S. Pat. No. 5,209,662 A, a riding simulation system of motorcycle;

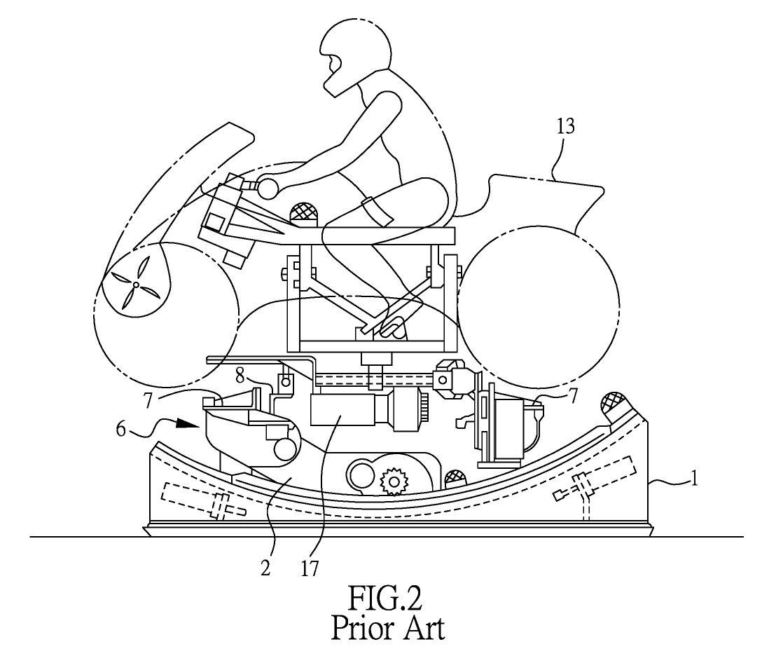

FIG. 3 is a side view of a first preferred embodiment according to the present invention;

FIG. 4 is a side view depicting a gaming unit of the first preferred embodiment;

FIG. 5 is a side view depicting the structure of the first preferred embodiment;

FIG. 6 is a side view depicting the leaning forward position of the first preferred embodiment;

FIG. 7 is a side view depicting the leaning backward position of the first preferred embodiment;

FIG. 8 is a side view of a second preferred embodiment according to the present invention;

FIG. 9 is a side view of a third preferred embodiment according to the present invention.

### DETAILED DESCRIPTION OF THE PREFERRED EMBODIMENTS

Specific structural and functional details disclosed herein will become apparent from the following description of the three preferred embodiments of the present invention taken in conjunction with the accompanying drawings. Before explaining the present invention in detail, it is to be understood that similar elements are labeled with the same reference numbers.

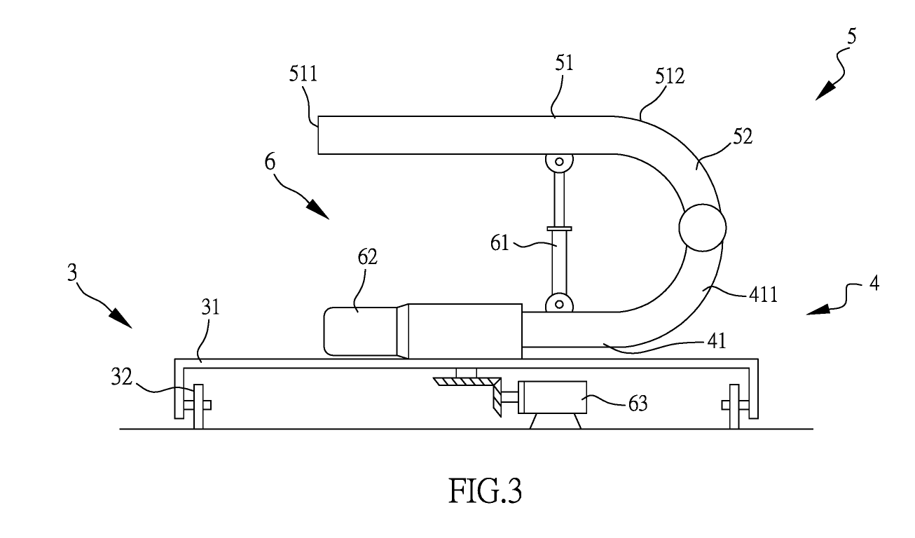

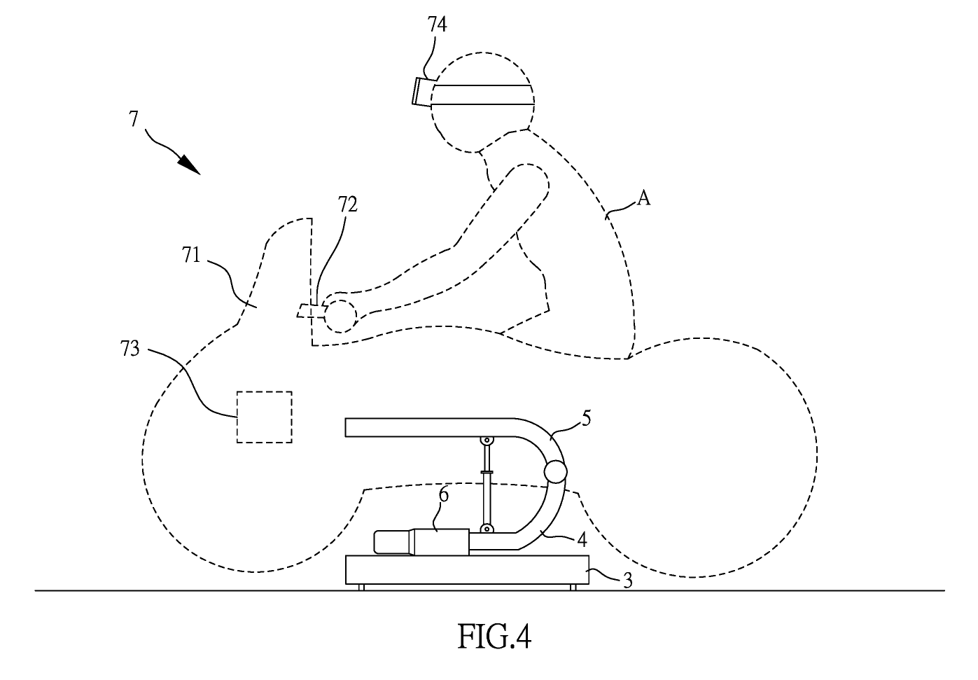

With reference to FIGS. 3 and 4, a first preferred embodiment according to an embodiment of the present invention is depicted, comprising a base unit 3, a rolling unit 4, a carrying unit 5, a power unit 6, and a gaming unit 7.

The base unit 3 includes a base platform 31, and a rotating member 32 located below the base platform 31. The rotating member 32 is a plurality of wheels or bearings located around bottom of the base platform 31, and a circle rail providing a plurality of wheels and bearings for moving, so that the base platform 31 can rotate around its vertical axis by the rotating member 32.

The rolling unit 4 includes a rolling base 41 pivotally connected to the base platform 31. Preferably, there is at least one bearing disposed on the base platform 31, and the rolling base 41 is disposed on the bearing, so that the rolling base 41 opposed to the base platform 31 can swing in leftward or rightward direction. A rolling supporting body 411 is stretched upward from the rolling base 41.

The carrying unit 5 includes a horizontal carriage body 51, and a vertical supporting body 52. The horizontal carriage body 51 is a cylindrical shape, and provided with a front end 511 and a rear end 512. The rear end 512 of the horizontal carriage body 51 is connected to top of the vertical supporting body 52, and bottom of the vertical supporting body 52 is pivotally connected to top of the rolling supporting body 411 of the rolling base 41.

The vertical supporting body 52 and the rolling supporting body 411 are presented in a curve shape, in accordance with the rolling base 41 and the horizontal carriage body 51, so that a U shape can be presented by the rolling unit 4 and the carrying unit 5.

Bottom of the vertical supporting body 52 is pivotally connected to top of the rolling supporting body 411, so that the horizontal carriage body 51 of the carrying unit 5 can pitch up and down.

The power unit 6 includes a first power component 61 controlling movement of the horizontal carriage body 51, a second power component 62 controlling left/right yaw of the rolling base 41, and a third power component 63 controlling the rolling of the base platform 31.

In the first preferred embodiment, the first power component 61 is an actuator whose length can be adjusted quickly. One end of the first power component 61 is connected to the horizontal carriage body 51, and the other end of the first power component 61 is connected to the rolling base 41.

By controlling the length of the first power component 61, the upward/downward movement of the horizontal carriage body 51 can be adjusted quickly. In this case, a rolling motor can be chosen as the first power component 61, being disposed between the vertical supporting body 52 and the rolling supporting body 411, so that the swing angle of the carrying unit 5 can be controlled, and so should not be construed as limiting the invention.

The second power component 62 is a rolling motor disposed on the base platform 31, so that the swing angle of the rolling base 41 can be controlled. The third power component 63 is another rolling motor disposed on the base platform 31, so that the yaw angle of the base platform 31 can be controlled. Using motors to control rotating mechanical system is a common technique, and so details related to this are not explained further herein.

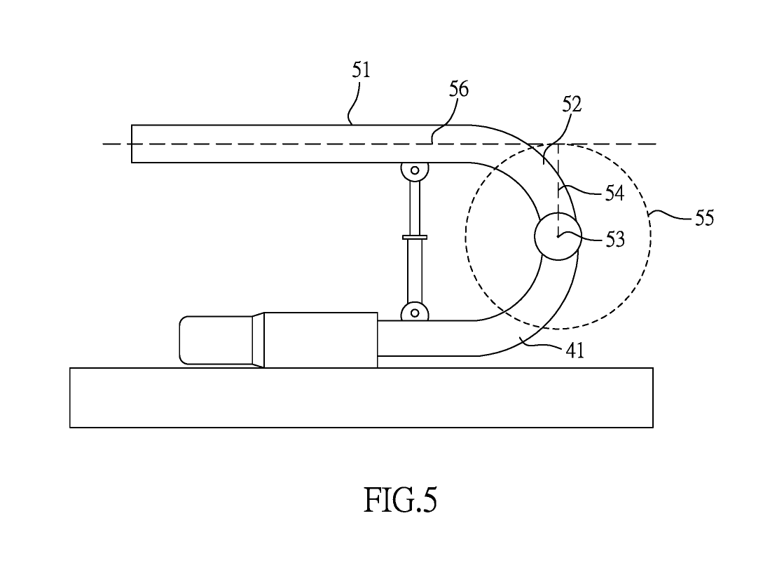

With reference to FIG. 5, a roll center 53 is defined where the vertical supporting body 52 is pivotally connected to the rolling base 41. A circle 55 can be obtained with center at roll center 53 and radius 54 equal to vertical length (tangent distance) of the vertical supporting body 52. The horizontal carriage body is disposed on a tangent line 56 to the circle 55.

It is worth mentioning that the rolling supporting body 411 is presented in a curved shape, and the horizontal carrying body 51 disposed on the tangent line 56 to the circle 55 is separated from the tangent point of circle 55 at certain distance, so that when the first power component 61 stretches out or retracts, the carrying unit 5 is controlled to move between a leaning forward or a leaning backward position. In this case, the radian measure of the front end 511 of the horizontal carriage body 51 is larger than the rear end 512.

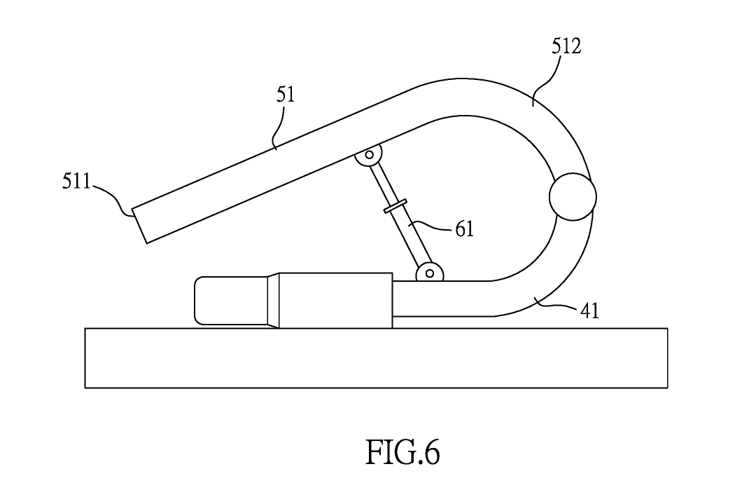

With reference to FIG. 6, the carrying unit 5 is presented in the leaning forward position. The first power component 61 retracts, and the horizontal carriage body 51 will move downward. The horizontal carriage body 51 is limited by the vertical supporting body 52 to be disposed on the tangent line 56 to the circle 55, so that the moving downward radian measure of the front end 511 of the horizontal carriage body 51 is larger than the rear end 512, and the height of the front end 511 of the horizontal carriage body 51 is lower than the rear end 512.

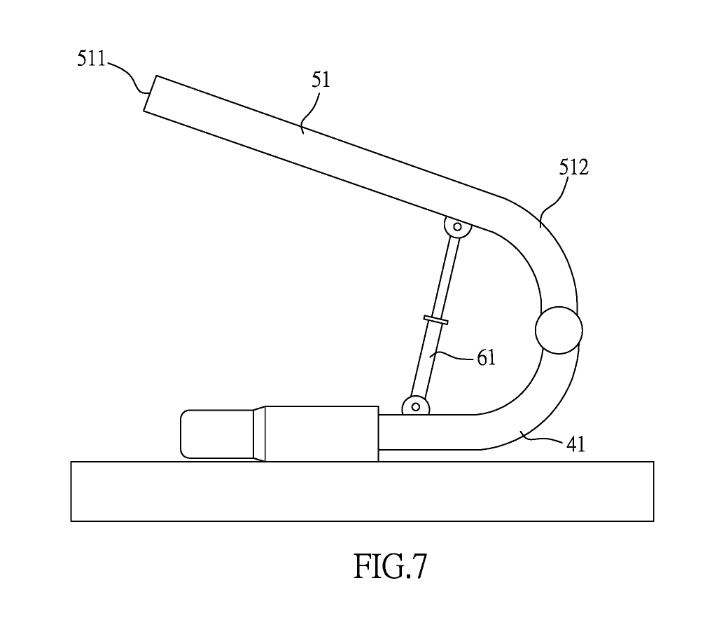

With reference to FIG. 7, the carrying unit 5 is presented in the leaning backward position. The first power component 61 stretches out, and the horizontal carriage body 51 will move upward. The horizontal carriage body 51 is limited by the vertical supporting body 52 to be disposed on the tangent line 56 to the circle 55, so that the moving upward radian measure of the front end 511 of the horizontal carriage body 51 is larger than the rear end 512, and the height of the front end 511 of the horizontal carriage body 51 is higher than the rear end 512.

The gaming unit 7 includes a seat member 71 located on the horizontal carrying body 51, an order detecting component 72 located on the horizontal carrying body 51, a game controlling component 73 for executing a game program, and a game display component 74 electrically connected to the game controlling component 73. The seat member is provided for a person A to ride.

The person A sends an order to the game controlling component 73 via the order detecting component 72, so that the game image can be shown on the game display component 74 by the game controlling component 73, and the power unit 6 can be controlled at the same time to provide the person A a riding experience.

Preferably, a computer device for executing a motorcycle game program is chosen as the game controlling component 73. The seat member 71 is a model motorcycle, and its head faces the front end 511 of the horizontal carriage body 51, while its tail faces the rear end 512 of the horizontal carriage body 51, so that the person A can straddle.

The order detecting component 72 can detect the motion of the motorcycle handle bars, such as throttle, braking, and turning, and the detected information is transmitted to the game controlling component 73, so that the person A can control the motorcycle in the game.

The game controlling component 74 in the first preferred embodiment is a head mount display, which offers the users a realistic visual experience by virtual reality technology, so that they can directly observe the objects in three-dimensional environment. In this case, a conventional display monitor can also be chosen as the game controlling component 74, and so should not be construed as limiting the invention.

When the person A sends a twisting throttle order via the order detecting component 72, the acceleration program will be executed by the game controlling component 73, and the corresponding acceleration image will be sent to the person A by the game controlling component 74. The carrying unit 5 will be controlled to move to leaning backward position, so that the person A can have experience which the front wheel rises up during acceleration.

When the person A sends a braking order via the order detecting component 72, the brake program will be executed by the game controlling component 73, and the corresponding braking image will be sent to the person A by the game controlling component 74. The carrying unit 5 will be controlled to move to leaning forward position, so that the person A can have experience which the front wheels lowers during braking.

When the person A sends a turning order via the order detecting component 72, and the turning program will be executed by the game controlling component 73, and the corresponding turning image will be sent to the person A by the game controlling component 74. Rotation of the base platform 3 and the swing of the rolling base 41 will be controlled, so that the person A can have knee down experience during turning.

The game controlling component 73 will calculate the motorcycle speed and radius of turning angle and decide whether the wheel slip condition is met. When the game controlling component 73 detects the turning speed is too fast, the wheel slip program will be executed, and the wheel slip image will be displayed to the person A by the game controlling component 74. Moreover, rotation of the base platform 31 and the swing of the rolling base 41 are controlled, and the carrying unit 5 will be moved to the leaning forward position quickly, so that the person A can have wheel slip experience with being thrown outward feeling.

It is worth mentioning that the prior art just uses the technique of rotating base for providing wheel slip effect, but it cannot provides with being thrown outward feeling. In the present invention, rotation of the base platform 31, and the swing of the rolling base 41 are used, and the carrying unit 5 can be moved to leaning forward position quickly, so that the person A can have realistic wheel slip experience with being thrown outward feeling.

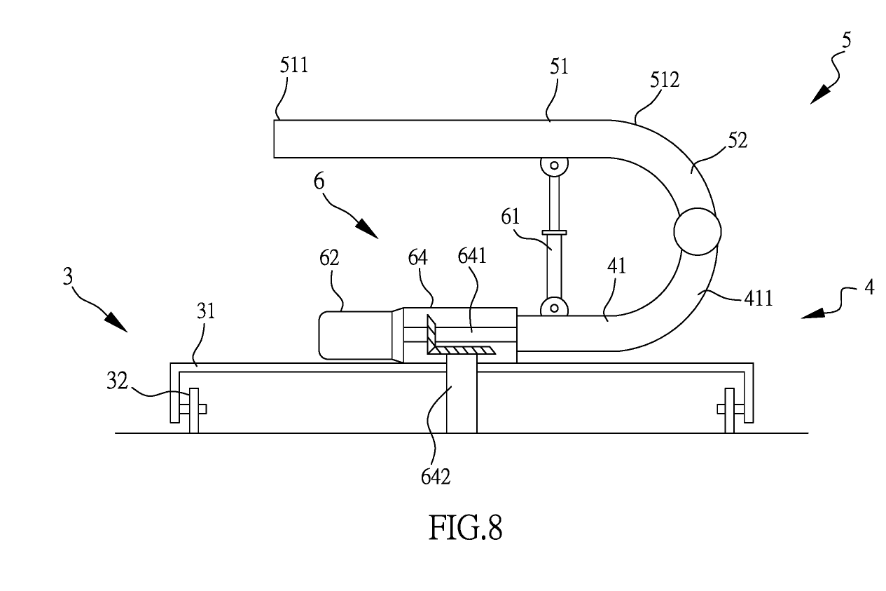

With reference to FIG. 8, a second preferred embodiment according to an embodiment of the present invention is depicted, which is similar to the first embodiment, and so common features are not described again. The difference is that the power unit 6 further includes a power transmission member 64 connected to the second power component 62 which can replace the third power component.

The power transmission member 64 is a toothed gear structure with two-axles output, including a first rotating axle 641 and a second rotating axle 642 for rotating simultaneously. The technique which using a motor to transmit power to two rotating axles is common for those in the field, and so details related to this are not explained further herein.

Preferably, the power transmission member 64 is fixed on the base platform 31, and the first rotating axle 641 is connected to the rotating base 41, and the second rotating axle 624 is fixed on the ground, so that the rotating base 41 and the base platform 31 driven by the second power component 62 can rotate at the same time.

When the person A sends a turning order via the order detecting component 72, and the turning program will be executed by the game controlling component 73, and the corresponding turning image will be sent to the person A by the game controlling component 74. Furthermore, the second power component 62 can be controlled, and rotation of the base platform 3 and the swing of the rolling base 41 will be controlled simultaneously, so that the person A can have knee down experience during turning.

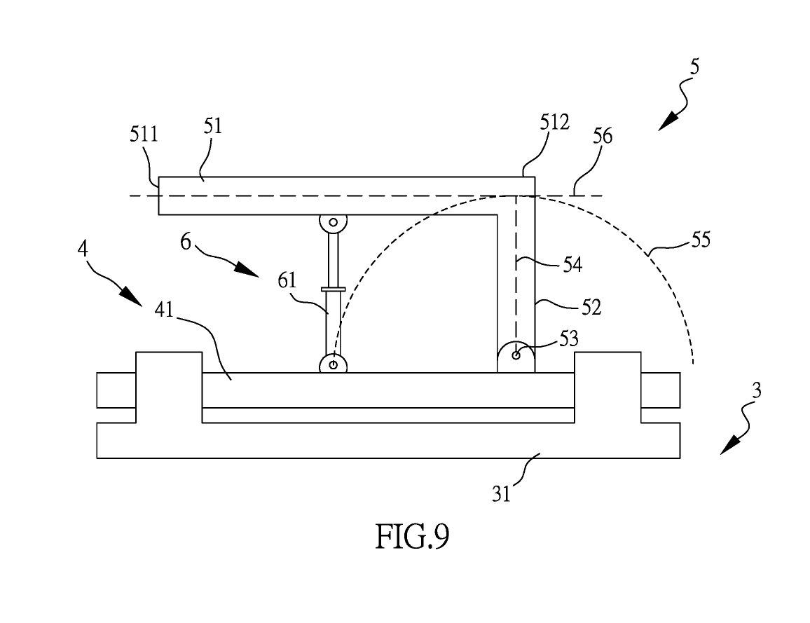

With reference to FIG. 9, a third preferred embodiment according to an embodiment of the present invention is depicted, which is similar to the first embodiment, and so common features are not described again. The difference is that the power unit 6 only includes the first power component 61 controlling movement of the horizontal carrying body 51.

Furthermore, the base platform 31 is fixed on the ground, and the vertical supporting body 52 is cylindrical. Bottom of the vertical supporting body 52 is directly pivotally connected to the rolling base 41, and the horizontal carriage body 51 is perpendicular to the vertical supporting body 52.

The roll center 53 is where bottom of the vertical supporting body 52 pivotally connected to the rolling base 41, and a circle 55 can be obtained with center at roll center 53 and radius 54 equal to vertical length of the vertical supporting body 52. The horizontal carriage body 51 is disposed on the tangent line 56 to the circle 55.

The person A′ feet can stand on the ground, and the carrying unit 5 can be leaned in rightward or leftward direction, so that the rolling base 41 can swing at a certain angle. The order detecting component 72 of the game unit 7 can detect the swing angle of the rolling base 41, so that the motorcycle's heading direction can be controlled. The technique that using leaning motorcycle body to control the operation of motorcycle game is common to those in the field, and so details related to this are not explained further herein.

It is worth mentioning that the horizontal carriage body 51 is disposed on the tangent line 56 to the circle 55, and the moving upward/downward radian measure of the front end 511 of the horizontal carriage body 51 is larger than the rear end 512, so that the game controlling component 73 of the game unit 7 can execute acceleration, braking, or wheel slip programs, and the person A can have more realistic riding experience.

With the aforementioned descriptions, the following benefits of the present method can be obtained:

1. Offering More Realistic Haptic Feedback

By the adjustable first power component 61, the carrying unit 5 can move between leaning forward or leaning backward position, and the horizontal carriage body 51 is disposed on the tangent line 56 of the circle 55, so that the motorcycle game can offer more realistic haptic feedback.

2. Reducing the Amount of Motors

The power transmission member 64 enables the second power component 62 to control rotation of the base platform 31 and the rolling base 41 simultaneously, and offers the person A the turning experience, so that the amount of motor can be reduced effectively.

3. Improving the Slip Experience

In the present invention, rotation of the base platform 31, and the swing of the rolling base 41 are used, and the carrying unit 5 can be moved to leaning forward position quickly, so that the person A can have realistic wheel slip experience with being thrown outward feeling. In conclusion, rotation of the base platform 31 and the swing of the rolling base 41 can provide more realistic turning experience, and with the operation of the first power component 61, the haptic feedback of acceleration, braking and wheel slip can be provided. Especially, when the carrying unit 5 is quickly moved to the leaning forward position by the first power component 61, the wheel slip experience with being thrown outward feeling can be presented, and the objective of the present invention can be achieved.

The foregoing detailed description is merely in relation to three preferred embodiments and shall not be construed as limiting the invention. It is to be understood that many other possible modifications and variations can be made without departing from the spirit and scope of the invention as hereinafter claimed.

What is claimed is:

1. A haptic feedback device with steering simulation, comprising:
a base unit, including a base platform;
a rolling unit, including a rolling base pivotally connected to the base platform, the rolling base opposed to the base platform being able to swing in leftward or rightward direction;
a carrying unit, including a horizontal carriage body, and a vertical supporting body, bottom of the vertical supporting body being pivotally connected to the rolling base, top of the vertical supporting body being connected to the horizontal carriage body; and
a power unit, including a first power component controlling movement of the horizontal carriage body.

2. The haptic feedback device with steering simulation as claimed in claim 1, wherein a roll center is defined where bottom of the vertical supporting body is pivotally connected to the rolling base, a circle being obtained with center at roll center and radius equal to vertical length of the vertical supporting body, and the horizontal carriage body is disposed on a tangent line to the circle.

3. The haptic feedback device with steering simulation as claimed in claim 2, wherein the first power component is an actuator.

4. The haptic feedback device with steering simulation as claimed in claim 3, wherein a rolling supporting body is stretched out from the rolling base, and top of the rolling supporting body is pivotally connected to bottom of the vertical supporting body.

5. The haptic feedback device with steering simulation as claimed in claim 4, wherein the rolling supporting body is a curve shape.

6. The haptic feedback device with steering simulation as claimed in claim 5, wherein the power unit further includes a second power component to control the swing of the rolling base.

7. The haptic feedback device with steering simulation as claimed in claim 6, wherein the base unit further includes a rotating member located below the base platform, to rotate the case platform.

8. The haptic feedback device with steering simulation as claimed in claim 7, wherein the power unit further includes a power transmission member, which is connected to the second power component, so that the rolling base and the base platform is driven by the second power component at the same time of rolling.

9. The haptic feedback device with steering simulation as claimed in claim 7, wherein the power unit further includes a third power component to control rotation of the base platform.

10. The haptic feedback device with steering simulation as claimed in claim 8, further includes a gaming unit which is provided with a seat member located on the horizontal carrying body, an order detecting component located on the horizontal carrying body, a game controlling component for executing a game program, and a game display component electrically connected to the game controlling component, wherein the seat member is provided for a person to ride, and the person sends an order to game controlling component via the order detecting component, the game image is shown on the game display component by the game controlling component, and the power unit is controlled at the same time.

11. The haptic feedback device with steering simulation as claimed in claim 9, further includes a gaming unit which is provided with a seat member located on the horizontal carrying body, an order detecting component located on the horizontal carrying body, a game controlling component for executing a game program, and a game display component electrically connected to the game controlling component, wherein the seat member is provided for a person to ride, and the person sends an order to game controlling component via the order detecting component, the game image is shown on the game display component by the game controlling component, and the power unit is controlled at the same time.
